(19) United States
(12) Patent Application Publication
(10) Pub. No.: US 2017/0083319 A1
(43) Pub. Date: Mar. 23, 2017

(54) GENERATION AND USE OF BLOCK BRANCH METADATA

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: Microsoft Technology Licensing, LLC, Redmond, WA (US)

(21) Appl. No.: 14/948,068

(22) Filed: Nov. 20, 2015

Related U.S. Application Data
(60) Provisional application No. 62/221,003, filed on Sep. 19, 2015.

(51) Int. Cl. G06F 9/30; G06F 9/38; G06F 12/08

(52) U.S. Cl. CPC G06F 9/3016; G06F 12/0862; G06F 12/0875; G06F 12/0811; G06F 9/3802; G06F 2212/452; G06F 2212/602; G06F 2212/62

(57) ABSTRACT

Apparatus and methods are disclosed for generating and using block branch metadata in block-based processor architectures. In one example of the disclosed technology, a block-based processor is configured to dynamically generate metadata representing control flow, exit points, and control flow probabilities for an instruction block while decoding and executing the block. The metadata can be used with subsequent invocations of the instruction block for branch and memory dependence predictions. In some examples, an incomplete portion of a control flow representation is generated for a number of predicated instructions and stored in a memory or storage device for enhancing prediction and prefetch for subsequent invocations of an instruction block.

### CROSS-REFERENCE TO RELATED APPLICATIONS

This application claims the benefit of U.S. Provisional Patent Application No. 62/221,003, entitled “BLOCK-BASED PROCESSORS,” filed Sep. 19, 2015, which application is incorporated herein by reference in its entirety.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for configuring, operating, and compiling code for, block-based processor architectures (BB-ISAs), including explicit data graph execution (EDGE) architectures. The described techniques and tools for solutions for, e.g., improving processor performance and/or reducing energy consumption can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, PDAs, touch screen tablet devices, tablet computers, wearable computers, and laptop computers.

In one example of the disclosed technology, a block-based processor is configured to dynamically generate metadata representing control flow, exit points, and/or control flow probabilities for an instruction block while decoding and executing the block. The metadata can be used with subsequent invocations of the instruction block for branch and memory dependence predictions. In some examples, an incomplete portion of a control flow representation is generated for a number of predicated instructions and stored in a memory or storage device for enhancing prediction and prefetch for subsequent invocations of an instruction block.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor core, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and instruction blocks, as can be used in some examples of the disclosed technology.

FIG. 5 illustrates block-based processor headers and instructions, as can be used in some examples of the disclosed technology.

FIGS. 6A and 6B illustrate example source and assembly code as can be used in certain examples of the disclosed technology.

FIGS. 7A and 7B illustrate operand, target, and predicate flow between instructions of an instruction block, according to certain examples of the disclosed technology.

FIG. 8 is a state diagram illustrating a number of states assigned to an instruction block as it is mapped, executed, and retired.

FIG. 9 illustrates a number of instructions blocks and processor cores, as can be used in some examples of the disclosed technology.

FIG. 10 is a flowchart outlining an example method of producing exit predictions for an instruction block, as can be performed in certain examples of the disclosed technology.

FIG. 11 illustrates an example of control flow within an example instruction block.

FIG. 12 is a flowchart outlining an example of generating control flow metadata and prediction hints, as can be performed in certain examples of the disclosed technology.

FIG. 13 depicts an example graph including exit type and metadata, as can be used in certain examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor uses an EDGE ISA designed for area- and energy-efficient, high-ILP execution. In some examples, use of EDGE architectures and associated compilers finesses away much of the register renaming, CAMs, and complexity.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

Apparatus, methods, and computer-readable storage media are disclosed for generation and use of block-based branch metadata for block-based processors. In certain examples of the disclosed technology, instruction blocks include an instruction block header and a plurality of instructions. In other words, the executed instructions of the instruction block affect the state, or do not affect the state as a unit.

In some examples of the disclosed technology, during execution of an instruction block, hardware circuitry of a block-based processor can detect and cache most likely paths of instruction execution for the block and exit prediction for the block, including exit type and target block for the exit. The branch and exit prediction can be performed by processor hardware, which builds a graph or tree representing instruction execution flow through the instruction block, and stores data for the graph or tree during program execution. For subsequent executions of the instruction block, the hardware can save block branch metadata including information represented as the height of a tree, instruction paths, and exit types.

On subsequent scheduling of the instruction block for execution, the processor can decode and scan the block, build the corresponding graph or tree, find exit types for exit points of the block, and generate and overall prediction of the most likely paths at exit types for the block. This allows the processor to generate more accurate branch predictions and perform earlier pipeline fetch and execution of data flow through the instruction block. By dynamically generating instruction block branch metadata, the block-based processor can dynamically adapt to make increasingly accurate predictions and avoid pipeline flushes.

In some examples, for use in making quick branch predictions, a block-based processor can store state of dynamically generated branch metadata in the instruction block header, including tree height, partial or full control flow paths, and exit types. Processor core hardware can then fetch likely target blocks of the predicted exit point. Thus, the header data can be further used to make more refined predictions of branches and memory accesses.

As will be readily understood to one of ordinary skill in the relevant art, a spectrum of implementations of the disclosed technology are possible with various area and performance tradeoffs.

### III. Example Block-Based Processor

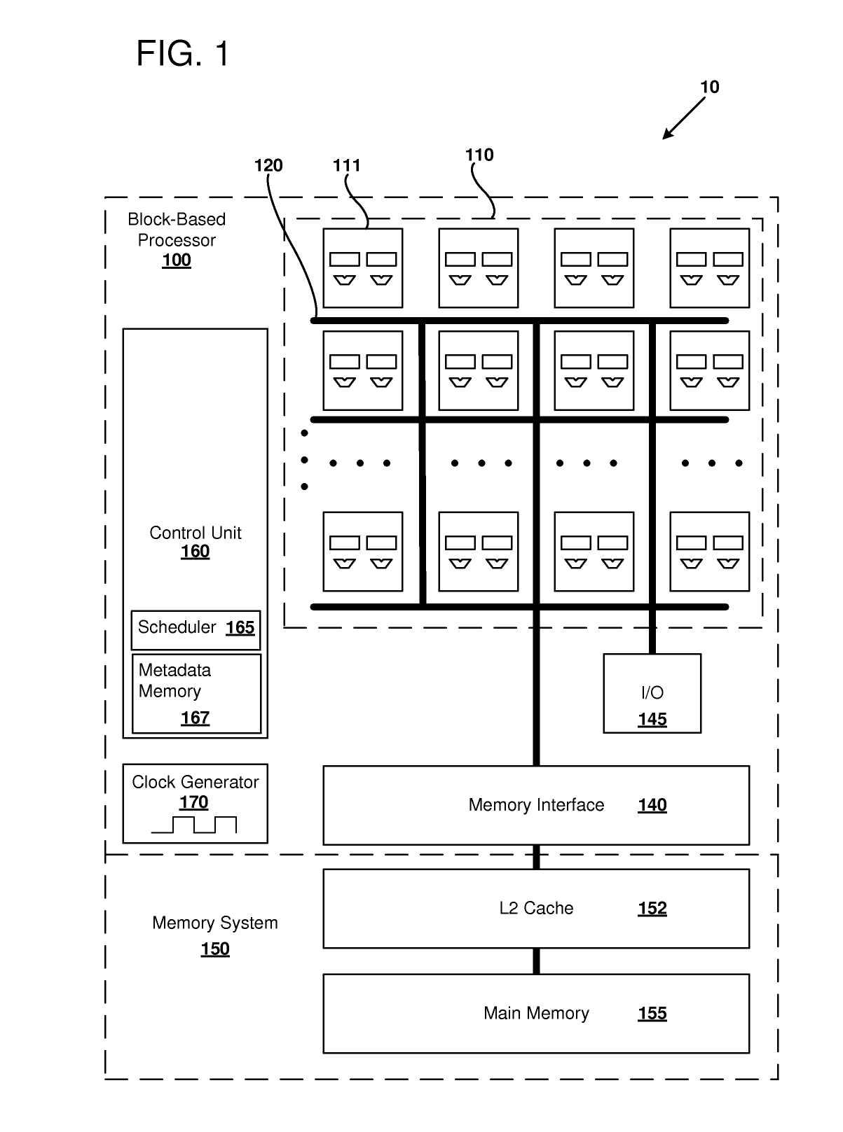

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (110) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. An external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can generate and control the processor according to control flow and metadata information representing exit points and control flow probabilities for instruction blocks.

The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 that is used to allocate instruction blocks to the processor cores 110. As used herein, scheduler allocation refers to directing operation of instruction blocks, including initiating instruction block mapping, fetching, decoding, execution, committing, aborting, idling, and refreshing an instruction block. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added. The scheduler 165 schedules the flow of instructions including allocation and de-allocation of cores for performing instruction processing, control of input data and output data between any of the cores, register files, the memory interface 140, and/or the I/O interface 145. The control unit 160 also includes metadata memory 167, which can be used to store data indicating execution flags for an instruction block.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

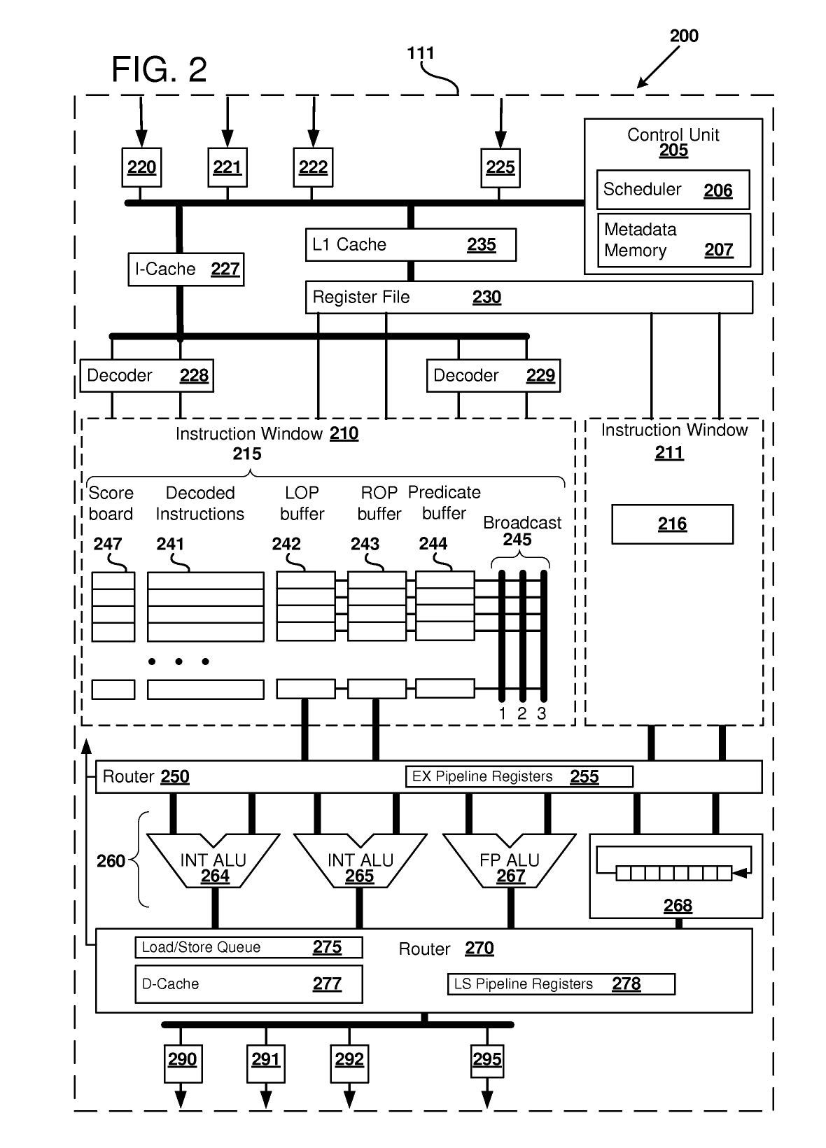

FIG. 2 is a block diagram further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which generates control signals to regulate core operation and schedules the flow of instructions within the core using an instruction scheduler 206. Operations that can be performed by the control unit 205 and/or instruction scheduler 206 can include generating and using block branch metadata representing control flow and exit points, allocation and de-allocation of cores for performing instruction processing, control of input data and output data between any of the cores, register files, the memory interface 140, and/or the I/O interface 145.

The control unit 205 can also include branch prediction circuitry that generates predictions of which instruction block(s) will be executed next. The branch prediction circuitry predicts which of a plurality of exit points of a block will be taken, and sends a signal that the control unit 205 uses to fetch, decode, and execute the next instruction block predicted. Any suitable branch prediction technique can be used. In some examples, a compiler or interpreter that generates the block-based processor instructions can include metadata in the block header or other location with hints for the branch prediction. In some examples, branch prediction is performed dynamically. For example, if an exit point is taken once, twice, or another number of times, then that exit point is designated as the predicted action for the next execution instance of the instruction block. In some examples, a table of instruction blocks and corresponding most likely exit points is maintained (e.g., in a user-visible, or non-user visible memory accessible to the control unit 205). In some examples, the predicted next instruction block is fetched, or fetched and decoded, but not executed until the previous block has committed. In some examples, block operands (e.g., from memory and/or registers) can be pre-fetched in addition to the next block instructions and block header. In some examples, the predicted next instruction block is also executed, event before the previous block has committed. In the event that the prediction is not correct (e.g., because the branch prediction was incorrect, or an exception occurs) the control unit 205 flushes the processor core speculatively executing the next predicted block, so that the processor state appears as if the incorrect branch was not taken.

In some examples, the instruction scheduler 206 is implemented using a general-purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general-purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

The control unit 205 further includes memory (e.g., in an SRAM or register) for storing control flow information and metadata. For example, control flow and metadata can be stored in metadata memory 207 that is accessible by the control unit 205 but that is not architecturally visible.

The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205 and/or instruction scheduler 206 are implemented at least in part using one or more of: hardwired finite state machines, programmable microcode, programmable gate arrays, or other suitable control circuits.

The exemplary processor core 111 includes two instructions windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, improved energy efficiency, and improved code compactness. In other examples, different numbers of instructions windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction headers and/or instructions for an instruction block and stores the decoded instructions within a memory store 215 and 216 located in each respective instruction window 210 and 211. Further, each of the decoders 228 and 229 can send data to the control unit 205, for example, to configure operation of the processor core 111 according to execution flags specified in an instruction block header or in an instruction.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (For convenient explanation, this application will refer to 32-bits of data as a word, unless otherwise specified. Suitable processors according to the disclosed technology could operate with 8-, 16-, 64-, 128-, 256-bit, or another number of bits words) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, execution flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associate with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, a predicate buffer 244, three broadcast channels 245, and an instruction scoreboard 247. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands and predicates are read from the operand buffers 242 and 243, and predicate buffer 244, respectively, not the register file. The instruction scoreboard 245 can include a buffer for predicates directed to an instruction, including wire-OR logic for combining predicates sent to an instruction by multiple instructions.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). The control unit can fetch and decode two instructions per clock cycle into each of the instruction windows 210 and 211. The control unit 205 provides instruction window dataflow scheduling logic to monitor the ready state of each decoded instruction's inputs (e.g., each respective instruction's predicate(s) and operand(s) using the scoreboard 245. When all of the input operands and predicates for a particular decoded instruction are ready, the instruction is ready to issue. The control unit 205 then initiates execution of (issues) one or more next instruction(s) (e.g., the lowest numbered ready instruction) each cycle, and control signals based on the decoded instruction and the instruction's input operands are sent to one or more of functional units 260 for execution. The decoded instruction can also encodes a number of ready events. The scheduler in the control unit 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and ready instructions can be scheduled in a first-in first-out (FIFO) order from the ready queue. For memory access instructions encoded with load store identifiers (LSIDs), the execution order will also follow the priorities enumerated in the instruction LSIDs, or by executed in an order that appears as if the instructions were executed in the specified order. Information stored in the scoreboard 245 can include, but is not limited to, the associated instruction's execution predicate(s) (such as whether the instruction is waiting for a predicate bit to be calculated and whether the instruction executes if the predicate bit is true or false), availability of operands to the instruction, or other prerequisites required before issuing and executing the associated individual instruction. The number of instructions that are stored in each instruction window generally corresponds to the number of instructions within an instruction block. In some examples, operands and/or predicates are received on one or more broadcast channels that allow sending the same operand or predicate to a larger number of instructions. In some examples, the number of instructions within an instruction block can be 32, 64, 128, 1,024, or another number of instructions. In some examples of the disclosed technology, an instruction block is allocated across multiple instruction windows within a processor core. Out-of-order operation and memory access can be controlled according to data specifying one or more modes of operation.

In some examples, restrictions are imposed on the processor (e.g., according to an architectural definition, or by a programmable configuration of the processor) to disable execution of instructions out of the sequential order in which the instructions are arranged in an instruction block. In some examples, the lowest-numbered instruction available is configured to be the next instruction to execute. In some examples, control logic traverses the instructions in the instruction block and executes the next instruction that is ready to execute. In some examples, only one instruction can issue and/or execute at a time. In some examples, the instructions within an instruction block issue and execute in a deterministic order (e.g., the sequential order in which the instructions are arranged in the block). In some examples, the restrictions on instruction ordering can be configured when using a software debugger to by a user debugging a program executing on a block-based processor.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 200 until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 include a load/store queue 275, which can be used to issue memory instructions, a data cache 277, which stores data being input to or output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core 200 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control unit 205 of the processor cores 110. The area, clock period, capabilities, and limitations substantially determine the realized performance of the individual cores 110 and the throughput of the block-based processor 100.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some cases, the scheduler 206 accepts events for target instructions that have not yet been decoded and must also inhibit reissue of issued ready instructions. In some examples, instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

Upon branching to a new instruction block, the respective instruction window(s) ready state is cleared (a block reset). However when an instruction block branches back to itself (a block refresh), only active ready state is cleared. The decoded ready state for the instruction block can thus be preserved so that it is not necessary to re-fetch and decode the block's instructions. Hence, block refresh can be used to save time and energy in loops.

### V. Example Stream of Instruction Blocks

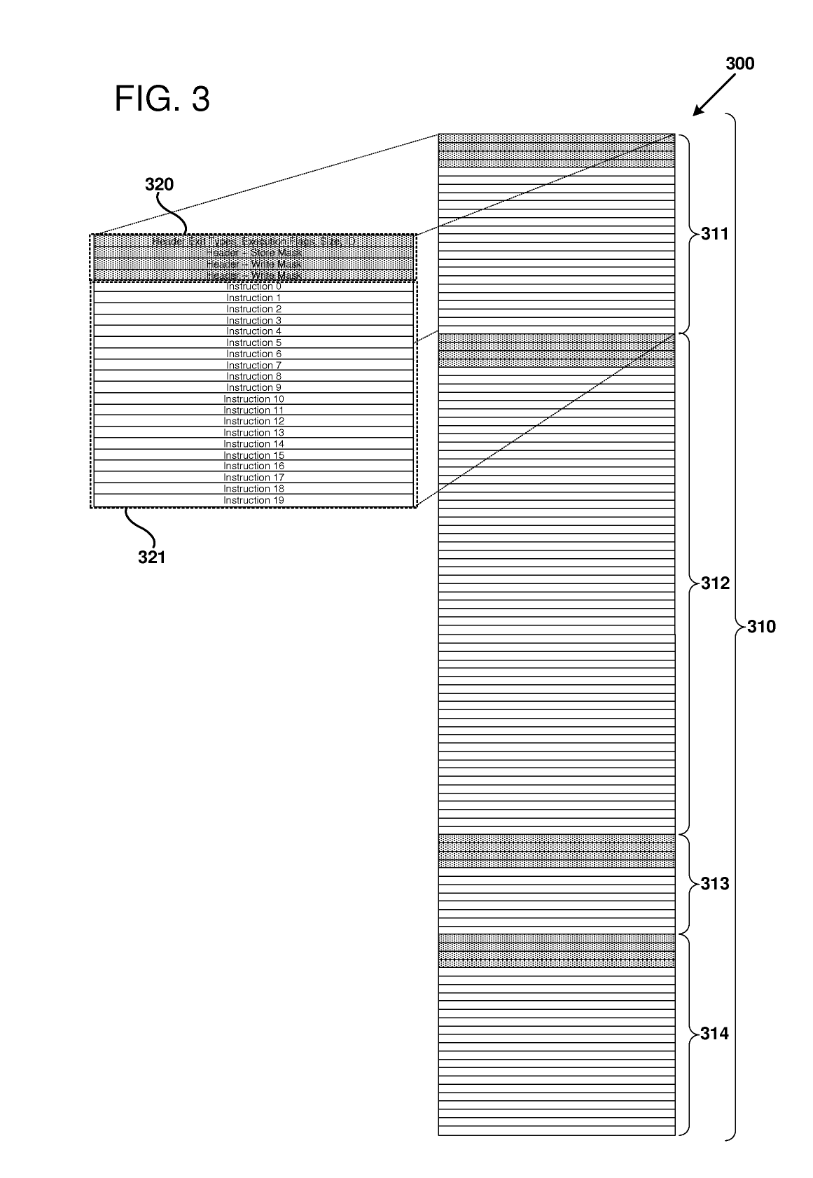

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. The stream of instructions can be stored in memory, received from another process in memory, received over a network connection, or stored or received in any other suitable manner. In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The illustrated instruction block header 320 also includes a store mask that indicates which of the load-store queue identifiers encoded in the block instructions are assigned to store operations. For example, for a block with eight memory access instructions, a store mask 01011011 would indicate that there are three memory store instructions (bits 0, corresponding to LSIDs 0, 2, and 5) and five memory load instructions (bits 1, corresponding to LSIDs 1, 3, 4, 6, and 7). The instruction block header can also include a write mask, which identifies which global register(s) the associated instruction block will write. In some examples, the store mask is stored in a store vector register by, for example, an instruction decoder (e.g., decoder 228 or 229). In other examples, the instruction block header 320 does not include the store mask, but the store mask is generated dynamically by the instruction decoder by analyzing instruction dependencies when the instruction block is decoded. For example, the decoder can analyze load store identifiers of instruction block instructions to determine a store mask and store the store mask data in a store vector register. Similarly, in other examples, the write mask is not encoded in the instruction block header, but is generated dynamically (e.g., by analyzing registers referenced by instructions in the instruction block) by an instruction decoder) and stored in a write mask register. The store mask and the write mask can be used to determine when execution of an instruction block has completed and thus to initiate commitment of the instruction block. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In some examples, the instructions include instructions for configuring the processor to operate according to one or more of operations by, for example, speculative execution based on control flow and metadata stored in a metadata memory (e.g., metadata memory 167 or 207). In some examples, data such as the number of cores to allocate to core fusion or vector mode operations (e.g., for all or a specified instruction block) can be stored in a control register. In some examples, the control register is not architecturally visible. In some examples, access to the control register is configured to be limited to processor operation in a supervisory mode or other protected mode of the processor.

### VI. Example Block Instruction Target Encoding

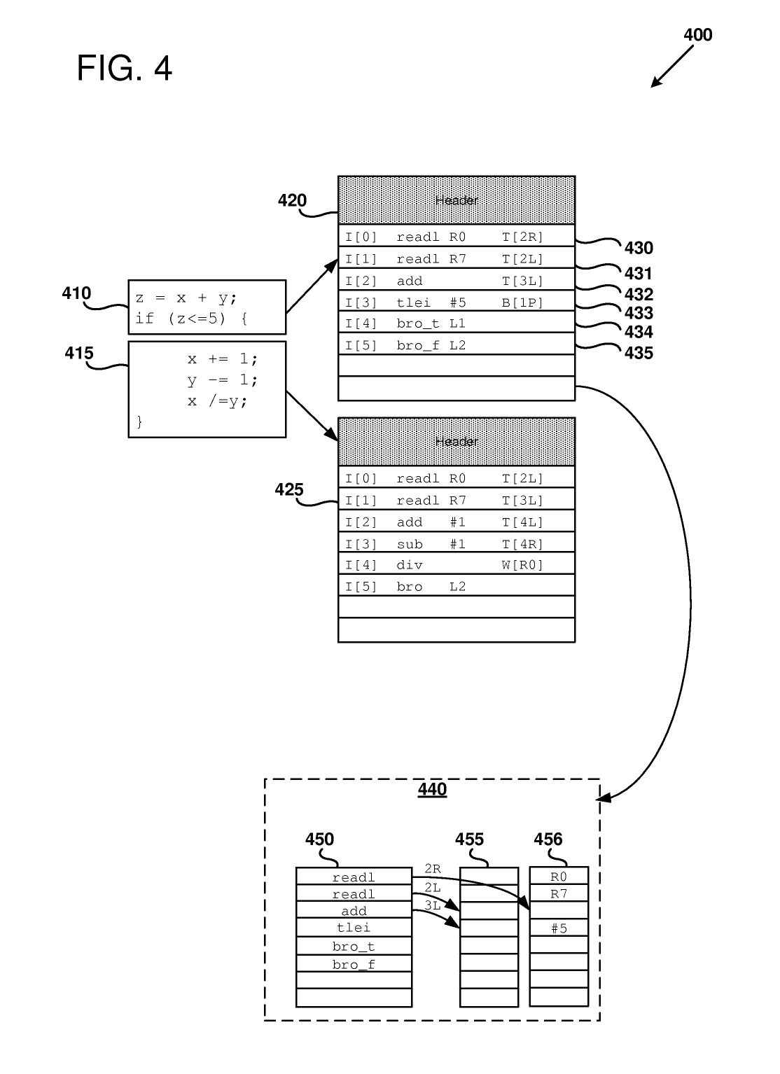

FIG. 4 is a diagram 400 depicting an example of two portions 410 and 415 of C language source code and their respective instruction blocks 420 and 425, illustrating how block-based instructions can explicitly encode their targets. In this example, the first two READL instructions 430 and 431 target the right (T[2R]) and left (T[2L]) operands, respectively, of the ADD instruction 432 (2R indicates targeting the right operand of instruction number 2; 2L indicates the left operand of instruction number 2). In the illustrated ISA, the READL instruction is the only instruction that reads from the user portion of the global register file (e.g., register file 230); however, any instruction can target the global register file. A READH instruction is used to access the system portion of the global register file. When the ADD instruction 432 receives the result of both register reads it will become ready and execute. It is noted that the present disclosure sometimes refers to the right operand as OP0 and the left operand as OP1, respectively.

When the TLEI (test-less-than-equal-immediate) instruction 433 receives its single input operand from the ADD, it will become ready to issue and execute. The test then produces a predicate operand that is broadcast on channel one (B[1P]) to all instructions listening on the broadcast channel for the predicate, which in this example are the two predicated branch instructions (BRO_T 434 and BRO_F 435). The branch instruction that receives a matching predicate will fire (execute), but the other instruction, encoded with the complementary predicated, will not fire/execute.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READL 430 and READL 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

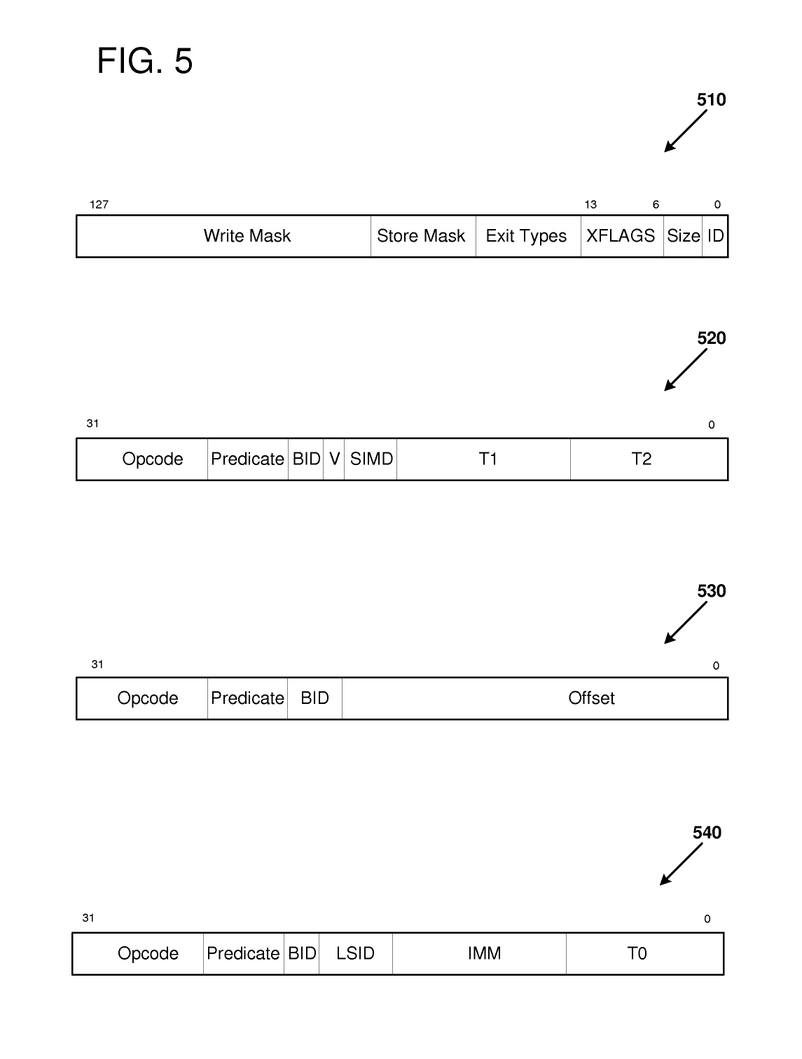

FIG. 5 is a diagram illustrating generalized examples of instruction formats for an instruction header 510, a generic instruction 520, a branch instruction 530, and a memory access instruction 540 (e.g., a memory load or store instruction). The instruction formats can be used for instruction blocks executed according to a number of execution flags specified in an instruction header that specify a mode of operation. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields, an instruction block size field, and an instruction header ID bit (the least significant bit of the instruction header).

The execution flag fields depicted in FIG. 5 occupy bits 6 through 13 of the instruction block header 510 and indicate one or more modes of operation for executing the instruction block. For example, the modes of operation can include core fusion operation, vector mode operation, branch predictor inhibition, memory dependence predictor inhibition, block synchronization, break after block, break before block, block fall through, and/or in-order or deterministic instruction execution. In some examples of the disclosed technology, bit 6 indicates vector mode operation, bit 8 indicates whether to inhibit a memory dependence predictor, and bit 13 indicates whether to force deterministic execution (e.g., execution in sequential order, or in a not-strictly sequential order that does not vary based on data dependencies or other varying operation latencies).

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10, including specification of the operand slot (e.g., left operation, right operand, or predicate operand). Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The memory access instruction 540 format includes an opcode field, a predicate field, a broadcast ID field (BID), a load store ID field (LSID), an immediate field (IMM) offset field, and a target field. The opcode, broadcast, predicate fields are similar in format and function as described regarding the generic instruction. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. The immediate field (e.g., and shifted a number of bits) can be used as an offset for the operand sent to the load or store instruction. The operand plus (shifted) immediate offset is used as a memory address for the load/store instruction (e.g., an address to read data from, or store data to, in memory). The LSID field specifies a relative order for load and store instructions within a block. In other words, a higher-numbered LSID indicates that the instruction should execute after a lower-numbered LSID. In some examples, the processor can determine that two load/store instructions do not conflict (based on the read/write address for the instruction) and can execute the instructions in a different order, although the resulting state of the machine should not be different than as if the instructions had executed in the designated LSID ordering. In some examples, load/store instructions having mutually exclusive predicate values can use the same LSID value. For example, if a first load/store instruction is predicated on a value p being true, and second load/store instruction is predicated on a value p being false, then each instruction can have the same LSID value.

### VIII. Example Source and Object Code

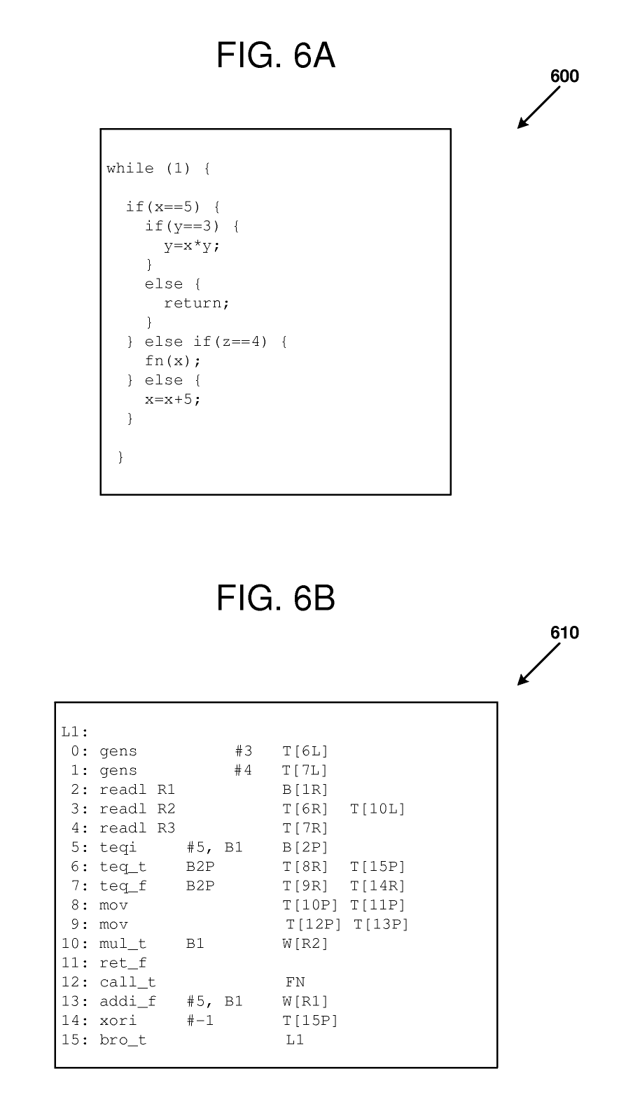

FIG. 6A illustrates a portion 600 of source code including a while loop and nested if statements. Each of the while statements and if statements includes a predicate in parenthesis. Block-based instructions generated from the source code portion 600 will include a number of exit points. For example, the return statement, the function call fn(x), as well as the while loop and subsequent instructions in the source code will result in exit blocks being generated in the instruction block object code. It should be noted that the example portion 600 source code is provided for illustrative purposes, and may vary from exact semantics of C language code, for ease of explanation.

FIG. 6B illustrates a portion 610 of block-based processor assembly code for a block-based processor generated from the portion 600 of source code depicted in FIG. 6A. The assembly code includes 15 block-based instructions, some of which specify their input operands, some of which specify their instruction targets, and some of which include immediate values. It should be readily understood that different assembly code can be generated for the same portion of source code based on, for example, performance constraints, target processor hardware, compilation algorithms used, and other considerations.

An example of instruction that specifies an input operand is READL instruction 2, which specifies input operand R1 (register 1) as its input operand. READL instruction 2 also specifies a target instruction, which in this case is B[1R] (broadcast channel one, right operand). Thus, data will be read from register R1 and sent to B[1R] when instruction 0 is executed. Other instructions specify instruction targets, for example, READL instruction 3 specifies targets named T[6R] (instruction 6, right operand) and T[10L] (instruction 10, left operand). Thus, data will be read from register R2 and sent to the two specified target instructions when instruction 3 is executed. Instruction predicates can also be targets, for example, instruction 8, mov, will send its input operand to the predicate input slot of instructions 10 and 11. An example of an immediate instruction is ADDI instruction 13, which will add the immediate value 5 to its input operand (and store at target register R1). Predicated instructions are denoted by _t or _f after the operand mnemonic. For example, instruction 6, TEQ_T, will not execute unless its input predicate value is true, and TEQ_F instruction 7 will not execute unless its input predicate value is false. The input predicate values of instructions 6 and 7 is the broadcast predicate on channel 2, which is set by the TEQI instruction 5.

The assembly code portion 610 can be converted to machine code for actual execution by a block-based processor.

### IX. Example Data Flow Illustration

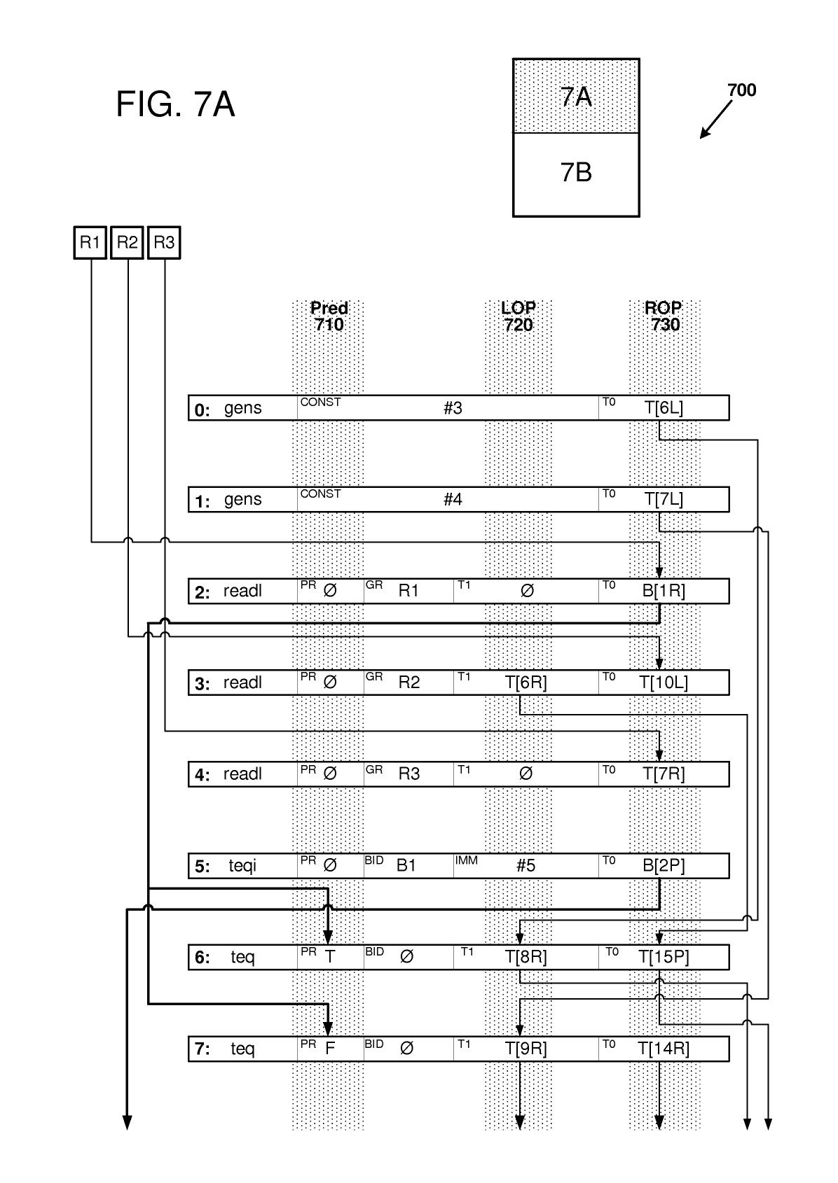

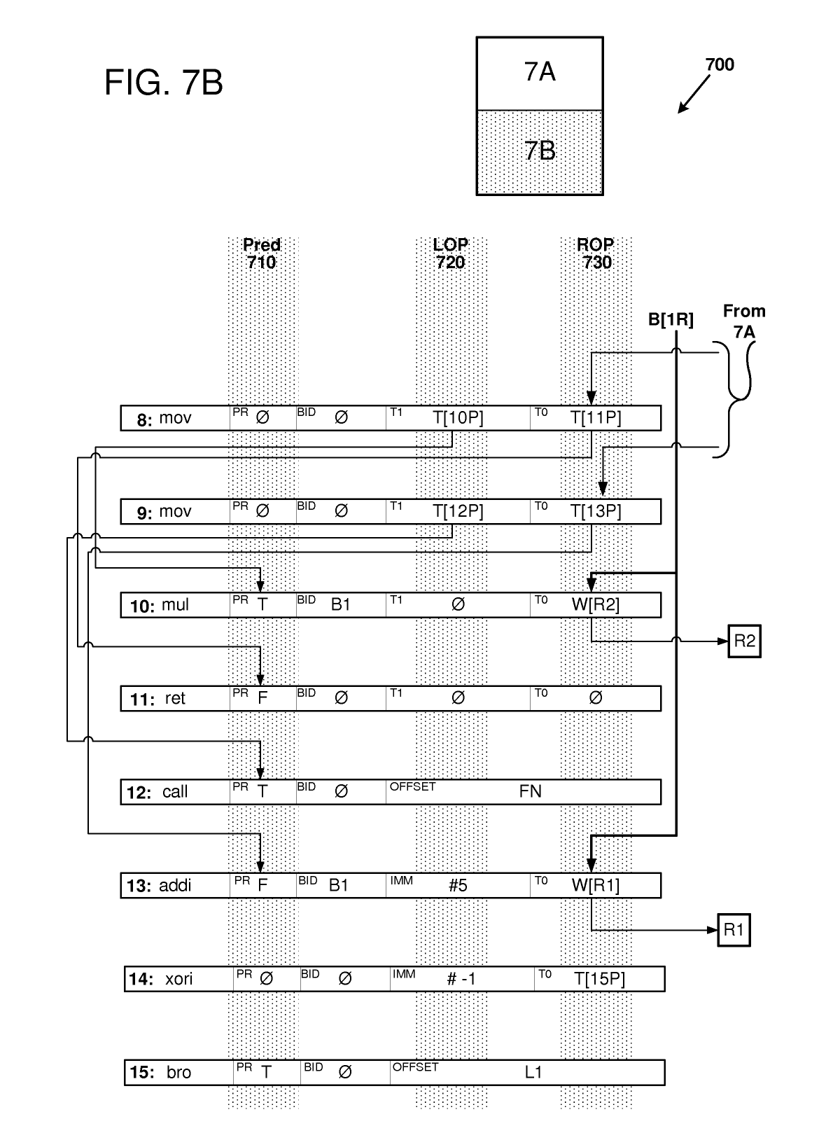

FIGS. 7A and 7B are a diagram 700 illustrating data flow for a number of the instructions shown in the assembly code portion 610 discussed above. As shown in FIGS. 7A and 7B, each instruction has access to a predicate slot 710, a left operand slot 720, and a right operand slot 730. Depending on the particular instruction, input can be received from one or more of these input slots. Also shown is operand data being received from a register file, including registers R1, R2, and R3, as well as registers being written to because they are specified as target operands, including registers R1 and R2. For example, instruction 2 is a register READL instruction that is not predicated (which, as shown, has a null predicate). Thus, instruction 2 will execute once all its input operands are available. The input operand specified is register R1, and the instruction has specified a single instruction target, which is the right operand of broadcast channel 1. Broadcast channels can be accessed by any appropriate instruction within an instruction block. Thus, a broadcast operand can be sent to zero, one, two, or even more instructions. Instruction 5 is a test if equal immediate instruction, which will compare an immediate value (here, the integer 5) to an input operand (here, the value on broadcast channel 1 right operand). Instruction 5 targets the predicate slot of broadcast channel 2, and thus its predicate is sent to instructions 6 and 7, as shown. Instruction 5 is not predicated. Instruction 6 is a test if equal immediate instruction, but is predicated on the result of broadcast channel 2 predicate. Thus, instruction 6 will not execute unless the broadcast predicate on channel 2 is true. Similarly, instruction 7 will not execute unless the predicate on broadcast channel 2 is false. The instructions also include branch instructions including instruction 11, which is a return instruction predicated on a false predicate, and instruction 12, which is a call instruction predicated on a true value. Thus, most of the instructions illustrated specify target operands for the instructions, but do not specified their own input operands. It should be noted that instruction 15, a branch offset instruction, is predicated on a wired-OR combination of the predicates generated by instruction 6 (corresponding to the test y==3) and the complement generated by instruction 14 of the predicate generated by instruction 7 (corresponding to the complement of z==4).

### X. Example Processor State Diagram

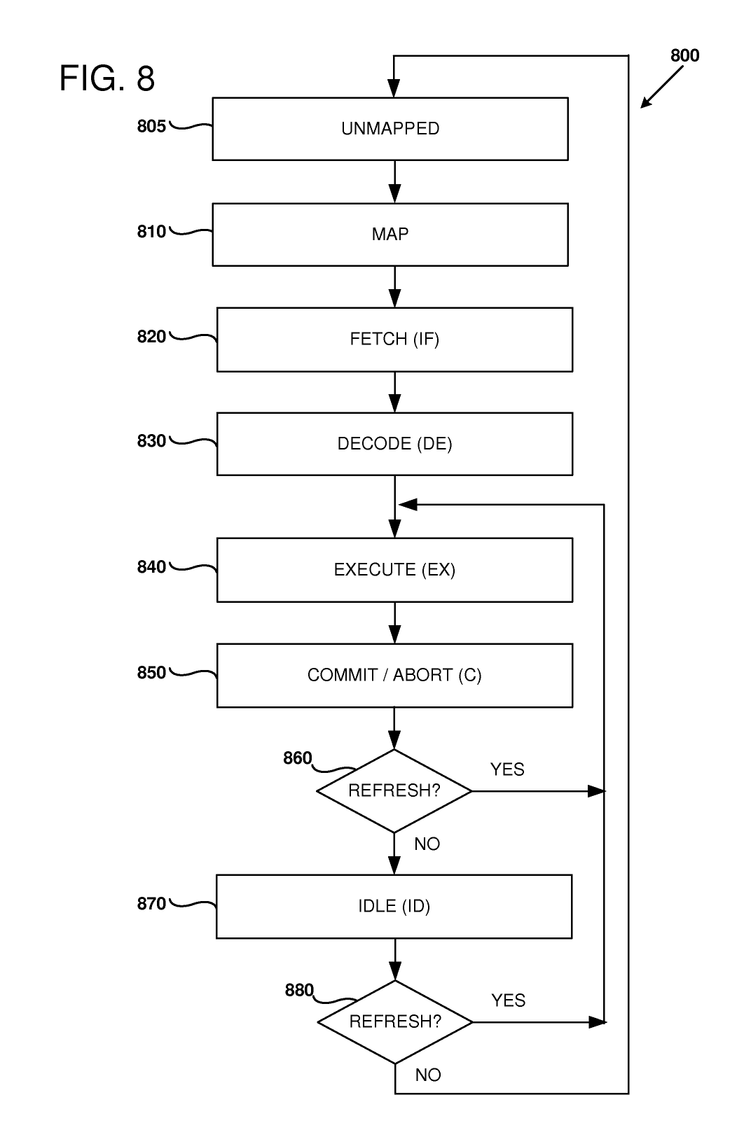

FIG. 8 is a state diagram 800 illustrating number of states assigned to an instruction block as it is mapped, executed, and retired. For example, one or more of the states can be assigned during execution of an instruction according to one or more execution flags. It should be readily understood that the states shown in FIG. 8 are for one example of the disclosed technology, but that in other examples an instruction block may have additional or fewer states, as well as having different states than those depicted in the state diagram 800. At state 805, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 810, control logic for the block-based processor, such as an instruction scheduler, can be used to monitor processing core resources of the block-based processor and map the instruction block to one or more of the processing cores.

The control unit can map one or more of the instruction block to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 820.

When the instruction block is in the fetch state 820 (e.g., instruction fetch), the mapped processor core fetches computer-readable block instructions from the block-based processor's memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 830.

During the instruction decode state 830, various bits of the fetched instruction are decoded into signals that can be used by the processor core to control execution of the particular instruction. For example, the decoded instructions can be stored in one of the memory stores 215 or 216 shown above, in FIG. 2. The decoding includes generating dependencies for the decoded instruction, operand information for the decoded instruction, and targets for the decoded instruction. Once at least one instruction of the instruction block has been decoded, the instruction block can proceed to execution state 840.

During the execution state 840, operations associated with the instruction are performed using, for example, functional units 260 as discussed above regarding FIG. 2. As discussed above, the functions performed can include arithmetical functions, logical functions, branch instructions, memory operations, and register operations. Control logic associated with the processor core monitors execution of the instruction block, and once it is determined that the instruction block can either be committed, or the instruction block is to be aborted, the instruction block state is set to commit/abort 850. In some examples, the control logic uses a write mask and/or a store mask for an instruction block to determine whether execution has proceeded sufficiently to commit the instruction block.

At the commit/abort state 850, the processor core control unit determines that operations performed by the instruction block can be completed. For example memory load store operations, register read/writes, branch instructions, and other instructions will definitely be performed according to the control flow of the instruction block. Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 860 to determine whether the instruction block should be refreshed. If the instruction block is refreshed, the processor core re-executes the instruction block, typically using new data values, particularly the registers and memory updated by the just-committed execution of the block, and proceeds directly to the execute state 840. Thus, the time and energy spent in mapping, fetching, and decoding the instruction block can be avoided. Alternatively, if the instruction block is not to be refreshed, then the instruction block enters an idle state 870.

In the idle state 870, the processor core executing the instruction block can be idled by, for example, powering down hardware within the processor core, while maintaining at least a portion of the decoded instructions for the instruction block. At some point, the control unit determines 880 whether the idle instruction block on the processor core is to be refreshed or not. If the idle instruction block is to be refreshed, the instruction block can resume execution at execute state 840. Alternatively, if the instruction block is not to be refreshed, then the instruction block is unmapped and the processor core can be flushed and subsequently instruction blocks can be mapped to the flushed processor core.

While the state diagram 800 illustrates the states of an instruction block as executing on a single processor core for ease of explanation, it should be readily understood to one of ordinary skill in the relevant art that in certain examples, multiple processor cores can be used to execute multiple instances of a given instruction block, concurrently.

### XI. Example Block-Based Processor and Memory Configuration

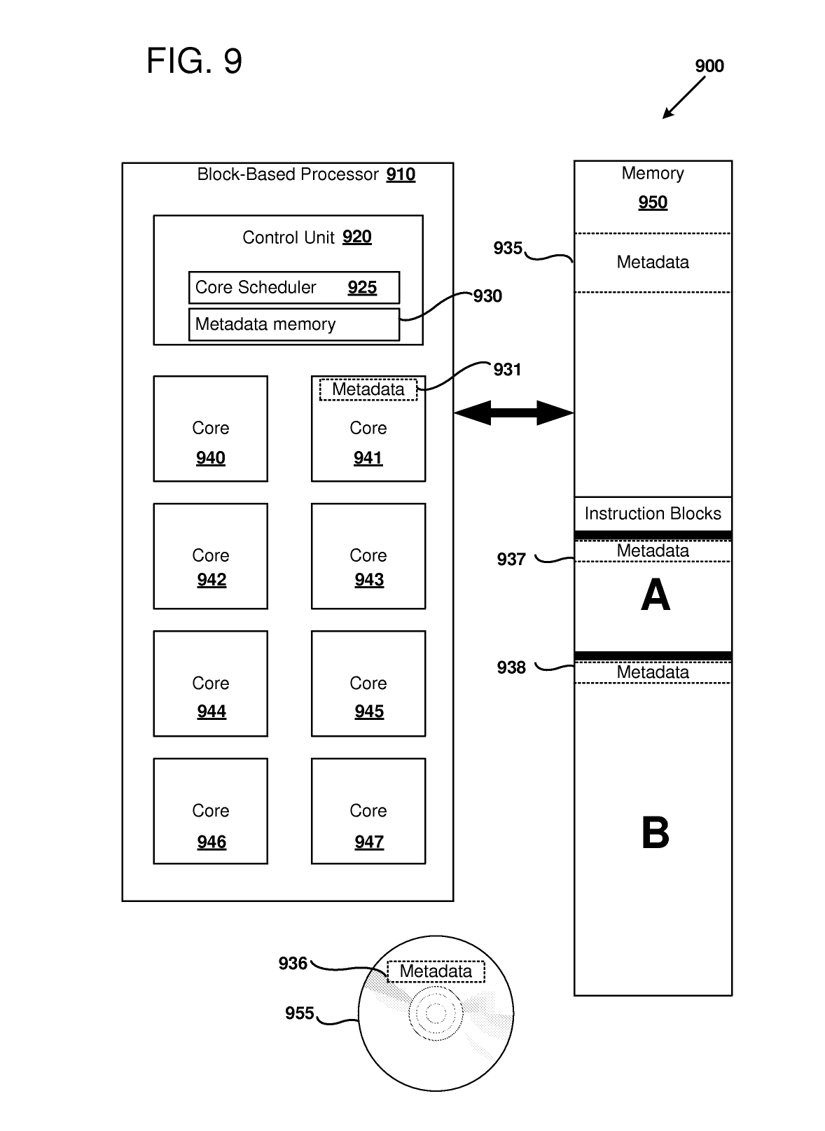

FIG. 9 is a diagram 900 illustrating an apparatus comprising a block-based processor 910, including a control unit 920 configured to execute instruction blocks according to data for one or more operation modes. The control unit 920 includes a core scheduler 925 and metadata memory 930. The core scheduler 925 schedules the flow of instructions including allocation and de-allocation of cores for performing instruction processing, control of input data and output data between any of the cores, register files, memory interfaces and/or I/O interfaces. The metadata memory 930 stores metadata including control flow representations (e.g., representing control flow of one or more instruction blocks as a tree or graph (e.g., a DAG) based on instruction predicates, and data indicating exit types and path likelihoods) which can be used to generate predictions for the associated instruction block. The metadata memory 930 can be implemented using SRAM, registers (e.g., including an array of flip-flops or latches) or other suitable memory storage technology.

The block-based processor 910 also includes one or more processor cores 940-947 configured to fetch and execute instruction blocks. The illustrated block-based processor 910 has up to eight cores, but in other examples there could be 64, 512, 1024, or other numbers of block-based processor cores. The block-based processor 910 is coupled to a memory 950 which includes a number of instruction blocks, including instruction blocks A and B, and to a computer-readable storage media disc 955. In some examples of the disclosed technology, metadata including control flow representations, exit types, and likelihoods can be stored in alternate locations than the meta data memory, including in a memory associated with each respective core (e.g., metadata memory 931 within the core 941), as a table 935 at a disjoint location than the instruction blocks in the memory 950, as portions 937 and 938 of instruction block headers (e.g., for instruction blocks A and B), or as sectors 936 in the storage media disc 955.

### XII. Example Method of Producing and Using Instruction Block Exit Prediction

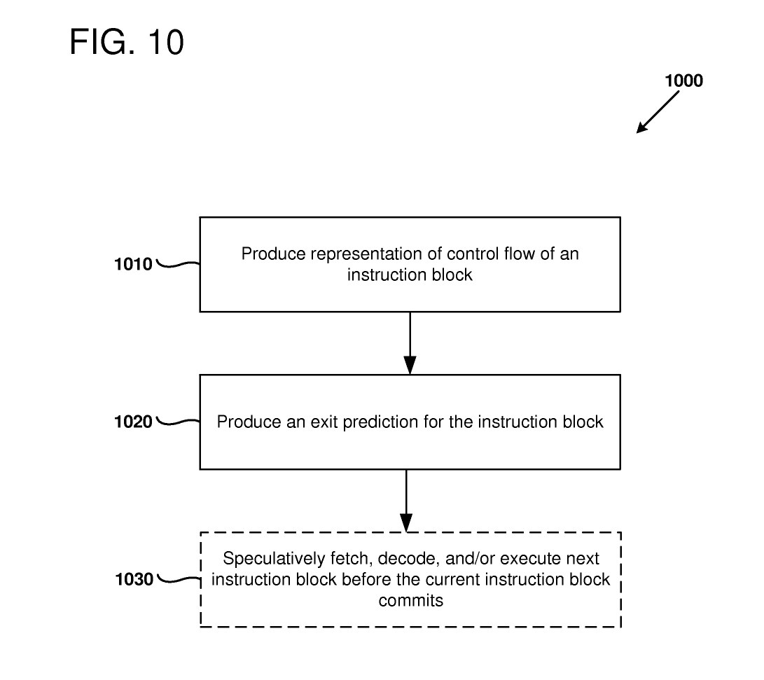

FIG. 10 is a flowchart 1000 outlining an example method of producing and using an exit prediction for an instruction block. In some examples, all or a portion of the illustrated method can be performed with an apparatus including one or more block-based processor cores configured to perform the method. In some examples, at least a portion of the method is performed with a compiler, for example, a compiler executing on a general-purpose processor, or a compiler executing on a block-based processor. In other examples, substantially all portions of the illustrated method are performed with a block-based processor, without use of a compiler, to produce the control flow representations and exit predictions discussed below.

At process block 1010, a representation of control flow for an instruction block is produced. For example, a block-based processor can fetch and decode instructions in an instruction block and analyze predicates within the instruction block in order to determine at least a portion of the control flow of the instruction block. The processor can build a graph or tree representation of the control flow based on predicates and branches (an example of block exit points) encoded therein. For example, a directed acyclical graph (DAG) can be used to represent control flow. In some examples, a compiler analyzes source code and/or object code for a block-based processor and produces a control flow representation by analyzing predicates and exit points of the instruction block. In some examples, one or more of the exit points of an instruction block are implied. For example, in some examples, an instruction block does not include an instruction to branch to the next sequential block, but instead the next sequential block is assumed to be the exit point if none of the other exit points are reached and predicates for the block have been evaluated.

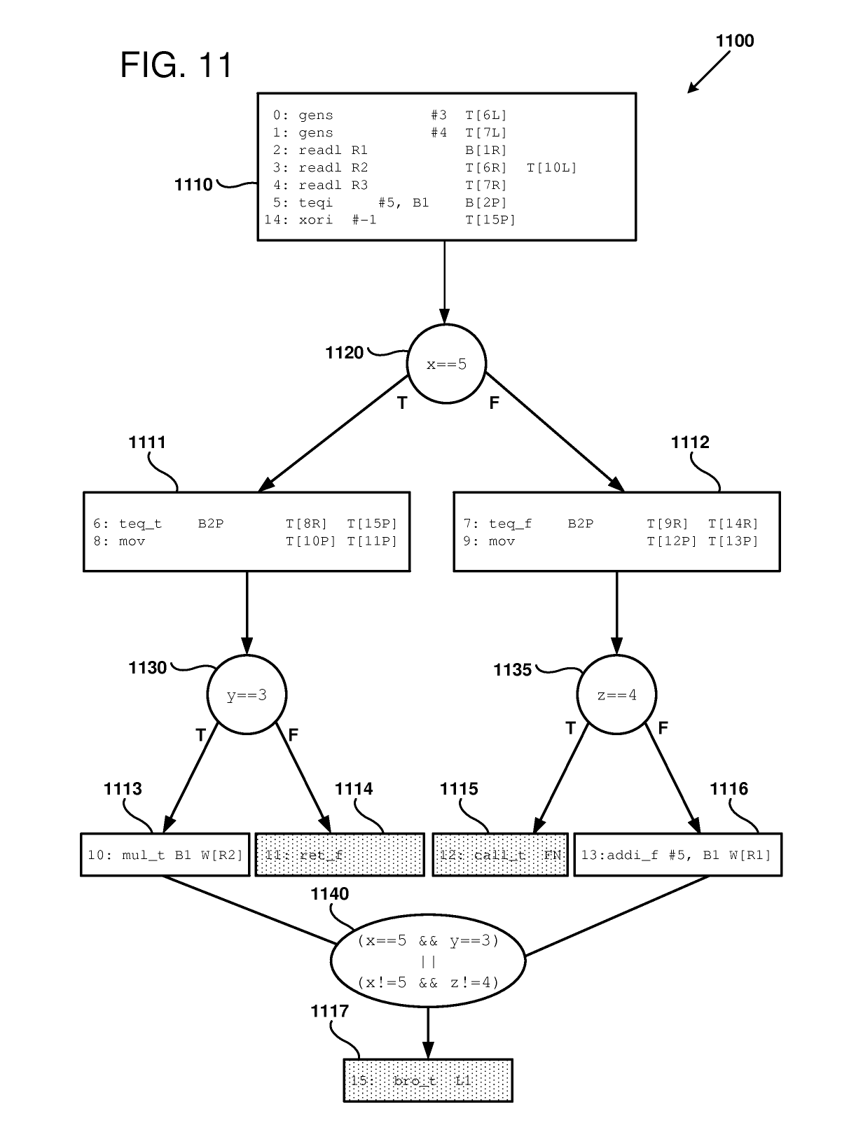

FIG. 11 is a DAG 1100 illustrating an example of control flow for the portion 610 of assembly code illustrated in FIG. 6B. The control flow in the DAG can be stored in memory in a number of different types of representations as will be discussed further below. Thus, the illustrated DAG 1100 is one example, but other representations are suitable, depending on the particular implementation.

As shown in FIG. 11, a first portion 1110 of the assembly code is not predicated. In other words, instructions 0-5 and 14 do not depend on receiving a predicate and will always execute once their input operands are available. Instructions 0 and 1 generate constants for use by other instructions in the block. Registers 2-5 are register reads targeting other instructions within the block. Instruction 14 (XORI) is provided to negate an operand provided by instruction number 7. Thus, instruction 14 produces a true value if z !=4 (z is not equal to 4). Also shown is a control flow node 1120, which is associated with the predicate x==5 (test if x is equal to 5), which is produced by instruction number 5. Thus, as shown, instructions in either a second portion 1111 of assembly code or instruction in a third portion of 1112 of assembly code, but not both, will be executed for a particular instance of the instruction block, depending on values determined for the illustrated TEQI instruction number 5. Thus, the instructions of assembly code portion 1111 will only execute if the test x==5 is true, and conversely assembly code portion 1112, including instructions 7 and 9 will only execute if the predicate x==5 is false.

Each side of the control node 1120 in turn has child nodes 1130 and 1135, each with their own predicate tests. Thus, assembly code portion 1113 including instruction 10 will only execute if and only if both the predicate of control flow node 1120 and the predicate of control flow 1130 evaluate to true. Similarly, assembly code portion 1114 will execute if and only if the predicate of control flow node 1120 is true and the predicate of control flow node 1130 is false. Assembly code portion 1115 will only execute if the predicate of control flow node 1120 is false and the predicate control flow node 1135 is true.

Portions 1114, 1115, and 1117 of the code, which are associated with exit points, are shaded. For example, assembly code portion 1114 includes an exit point, instruction 11, which is a return instruction, predicated on node 1130 producing a false predicate and assembly code portion 1115 has a call instruction exit point, which is predicated on node 1135 producing a true predicate.

Control flow node 1140 represents the predicate ((x==5 & & y==3)∥(x!=5 & & z!=4). In other words, control flow node 1140 can be reached if either control flow node 1130 produces a true predicate, or if control flow node 1135 produces a false predicate. Since neither node 1130 nor 1135 can be reached without evaluating predicate node 1120, the predicate test for control flow node 1140 can be simplified to y==3∥z!=4. It should be noted that the associated branch offset instruction 15 is predicated on wired-OR logic of two predicates: the predicate generated by instruction 6, and the predicate generated by instruction 14. The xori #-1 instruction generates the logical complement of z==4 so that a single bro_t instruction (the “_t” indicating a predicated on a true condition) can be used. In the depicted embodiment, any number of predicates within an instruction block can be sent to a predicated instruction, reducing the need to add instructions to calculate complex predicates. In some examples, a wired-OR is used to combine a plurality of predicates. In other examples, a wired-AND is used to combine a plurality of predicates. In other examples, two BRO instructions, one predicated false and the other predicated true, could have been used instead of generating the logical complement of z==4.

Once the representation of control flow is produced, the method proceeds to process block 1020. It should be noted that the representation can be generated in a number of different ways. For example, the control flow representation can be generated when decoding an instruction block by generating metadata representing at least a portion of control flow of the decoded instruction block and storing the metadata in memory. In some examples, all of the control flow of an instruction block is used to generate metadata, while in other examples, only a portion is used (e.g., only the first, second, or third levels of control flow are used to generate the metadata). In some examples, the metadata is used for generating predictions for the currently executing instruction block, while in other examples, the metadata is used for future instances of the instruction block from which the metadata was generated. In some examples, generating the metadata includes representing likelihoods for one or more control paths of the instruction block to be taken. In some examples, the generated metadata is stored in a memory in one or more of the following forms: as an instruction block header, at a memory location disjoint from the instruction block, in a memory store for a processor core instruction window, or in a memory store that was generated with a previous execution of the instruction block. In some examples, the metadata can be stored in computer-readable storage media for use with future executions of the instruction block. In some examples, the metadata is generated at least in part using an instruction profiler.

At process block 1020, an exit prediction is produced for the instruction block. For example, each of the control flow paths can have metadata stored that indicates an exit type associated with a predicate path. The prediction can be generated in a number of different ways, including analysis of loops, historical data from previous instances of executing an instruction block, or other suitable means. Once an exit prediction is produced, the method proceeds to process block 1030.

At process block 1030, the exit prediction is used to speculatively fetch, decode, and/or execute the next instruction block before the current instruction block commits. Thus, metadata including likelihoods for various control flow paths can be used to select one or more exit points of the instruction block, calculate a memory address associated with the one or more next instruction blocks, and begin speculative execution for one or more instruction blocks. In some examples, speculation is only used for one subsequent block, while in other examples, two or more blocks along different control flow path exit points can be speculatively fetched, decoded, and/or executed. In some examples, the method includes speculatively fetching a data operand for a register read instruction for a next instruction block indicated by a predicted exit point. In some examples, the method includes speculative fetching data operands for a memory load instruction for a next instruction block indicated by a predicted exit point. In some examples, the method includes, based on a predicted exit point, speculatively calculating an address of a memory operand, or an address of a next instruction block indicated by a predicted exit point. Thus, by generating metadata for control flow of instruction blocks, performance of a block-based processor can be improved and/or more reliable branch and memory prediction can be achieved.

### XIII. Example Method of Generating Metadata

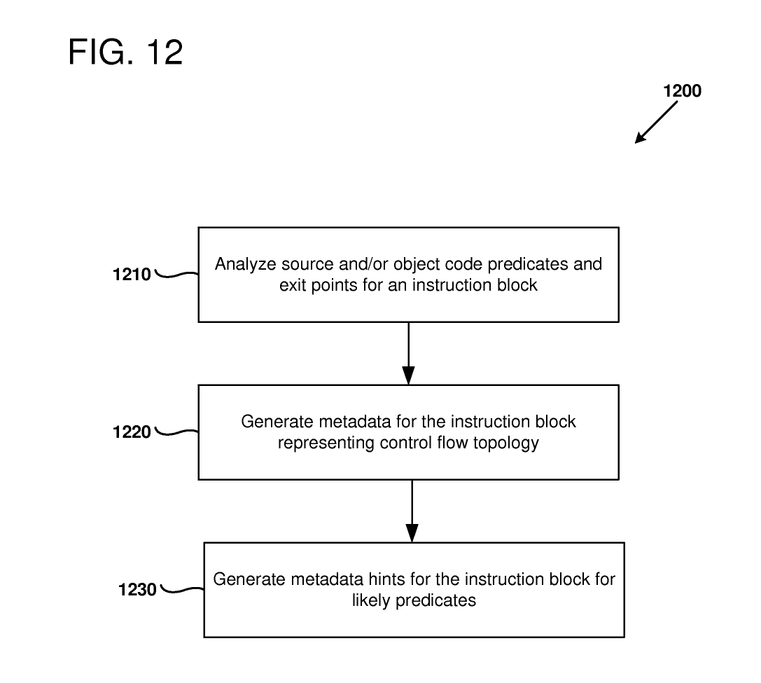

FIG. 12 is a flowchart 1200 outlining an example method of generating metadata for use in a block-based processor while executing instruction blocks according to the disclosed technology. For example, the block-based processor discussed above regarding FIGS. 1 and 2 can be used to implement the example method.

At process block 1210, source code and/or object code is analyzed, including instruction predicates and exit points for an instruction block. If source code is analyzed, it is typically transformed into an intermediate language or assembly language for a block-based processor before being analyzed. The analyzing can include generating a representation of control flow for one or more instruction blocks specified in the code. For example, a tree or graph, including a DAG, can be used to represent control flow for the instruction block. FIG. 11 illustrates an example control flow representation that can be used with a method of FIG. 12, but as will be readily understood to one of ordinary skill in the relevant art, other suitable representations can be used. Exit points can be identified by identifying corresponding instructions, including relative branch instructions, absolute branch instructions, branches to a register value, call instructions, return instructions, and in some examples, implicit branch instructions, depending on the particular instruction set architecture of the processor. Once instruction block predicates and exit points have been analyzed, the method proceeds to process block 1220.

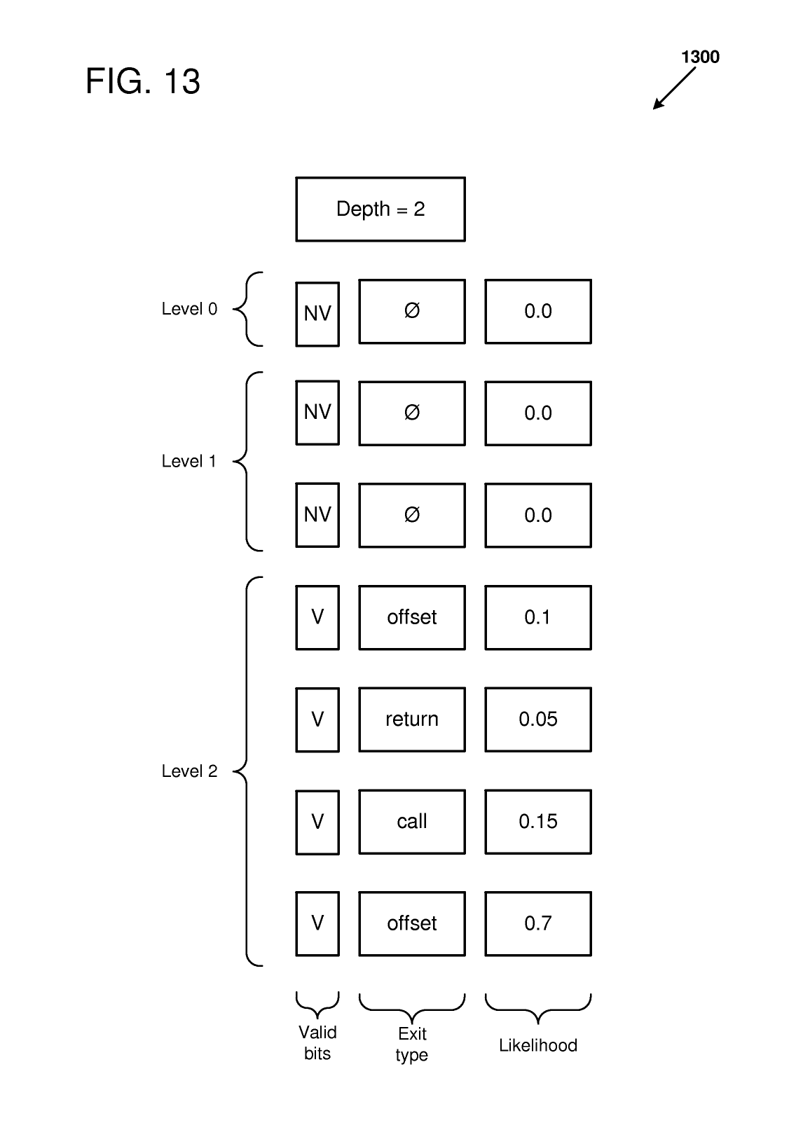

At process block 1220, metadata is generated representing at least a portion of control flow topology for an instruction block based on the analysis of predicates and exit points performed at process block 1210. The metadata can be stored in memory or other storage accessible by a core processor control unit. An example arrangement of metadata is discussed further below with respect to FIG. 13. For example, the metadata can be stored as a tree within an array, as identifiers in a sparse array, with a content addressable memory (CAM), or other suitable hardware.

At process block 1230, metadata hints are generated for the instruction block based on predicates that are determined to be more likely to be taken. For example, metadata hints can include memory addresses of next instruction blocks to be executed, addresses of memory operands, register addresses, branch addresses, or other suitable hints. The hints generated a process block 1230 can be used by, for example, a memory dependence predictor or a branch predictor in order to improve performance of the block-based processor by allowing for improved speculative execution.

In some examples, metadata representing likelihoods associated with particular paths of control flow is generated. For example, static analysis of the instruction block code, or historical analysis of an executing instruction block can be used. In some examples, counters are used to count the number of times that an instruction block uses a particular exit point. After an instruction block has been executed for a sufficient number of times, the counter data can be accessed and stored with the metadata representation for future use. In some examples, the metadata is stored in a register accessible by the control unit only, while in other examples the metadata can be stored in a generally accessible memory or saved with the instruction block instructions for use in future execution of the instruction block.

FIG. 13 is a diagram 1300 illustrating an example format for representing control flow and associated metadata for the DAG 1100 of FIG. 11. For example, the example format can be used with the method outlined in FIG. 12. The control flow and metadata representation illustrated in FIG. 13 can be stored in a memory that is accessible by a block-based processor core control unit, but not by the processor user, while in other examples the data can be stored in a generally accessible location, such as a main memory or in a computer-readable storage device. The illustrated representation begins with data indicating the depth of a control flow DAG, which depth is 2 in the illustrated example. The illustrated DAG includes exit types and likelihood metadata for three levels of the DAG. Because there is no exit point associated with level 0, a valid bit for level 0 is set to not valid and the exit type and likelihood data are set to null and 0, respectively. This is because there are no unpredicated branches in the control flow of FIG. 11. Similarly, level 1 of the DAG also does not include exit points, and so the not valid bits for the left and right memory locations in the memory array are set to not valid. These memory locations correspond to the assembly code portions 1111 and 1112 illustrated in FIG. 11. Level 2 of the tree includes information for three exit points. A first exit point where control flow nodes 1120 and 1130 are each true corresponds to assembly code portion 1117, which is a branch with offset having a likelihood of 0.1. Assembly code portion 1114 is associated with a return exit type which is indicated in the DAG and a likelihood of 0.05. Assembly code portion 1115 which is for a call instruction exit type is associated with a likelihood of 0.15. Assembly code portion 1116 is associated with an exit type of branch offset and a likelihood of 0.7. Thus, for subsequent invocations of the illustrated instruction block, the block-based processor core can use the metadata to determine that assembly code portion 1116 and 1117 is the most likely exit point. Thus, the block-based processor can fetch, decode, and execute the instruction block referenced by assembly code portion 1117 with a higher degree of confidence. In some examples, the exit types and likelihood data are stored in main memory at a location associated with the respective instruction block. In some examples, the exit types and metadata are stored in an instruction block header of the respective instruction block. In some examples, the metadata and exit types are stored in registers or memory accessible to a processor core control unit, but not accessible to the user. In some examples, a memory is accessible by the control unit of two or more processor cores, but is not visible to the user.

### XIV. Exemplary Computing Environment

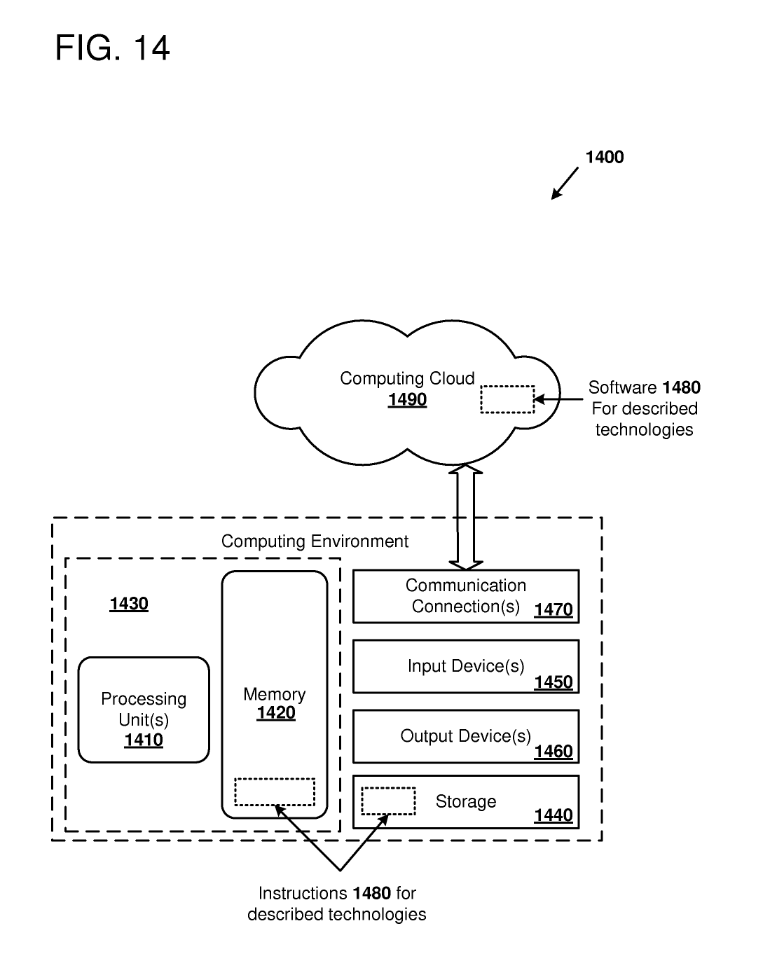

FIG. 14 illustrates a generalized example of a suitable computing environment 1400 in which described embodiments, techniques, and technologies, including configuring a block-based processor, can be implemented. For example, the computing environment 1400 can implement disclosed techniques for configuring a processor to operating according to one or more instruction blocks, or compile code into computer-executable instructions for performing such operations, as described herein.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input device(s) 1450, one or more output device(s) 1460, and one or more communication connection(s) 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XV. Additional Examples of the Disclosed Technology

Additional examples of the disclosed subject matter are discussed herein in accordance with the examples discussed above. It will be readily understood by one of ordinary skill in the art that the exemplary systems, methods, and apparatus described herein should not be construed as being limiting in any way, and are not limited to any specific aspect or feature or combinations thereof.

In some examples of the disclosed technology, an apparatus includes one or more block-based processor cores having one or more execution units configured to execute instruction blocks, each of the instruction blocks having one or more exit points. The cores further include a control unit configured to execute a current one of the instruction blocks by reading metadata stored in a memory associated with the current instruction block and based on the read metadata, generating a predicted one of the exit points which will be taken upon executing the current instruction block. Instructions organized within the instruction block are fetched, executed, and committed atomically, in other words, the instruction block will compute and commit as a complete transaction. In some examples, the control unit is further configured to decode an instruction block by generating metadata representing at least a portion of control flow of the decoded instruction block store the metadata in a memory. In some examples, the control unit is further configured to: generate metadata for executing instruction blocks representing likelihoods of one or more control paths of the instruction block being taken and store the generated metadata in the memory. The stored metadata can be referenced by subsequent instances of execution for the instruction block. In some examples, the metadata is stored and referenced by a single core. In other examples, the metadata can be accessed by other cores when executing the instruction block. In some examples, the metadata is temporarily stored only for a particular invocation of a thread or process, while in other examples, at least a portion of the metadata is persisted to subsequent threads or processes executing the instruction block.

In some examples, the control unit is further configured to, based on the predicted exit point, speculatively fetch and execute a next instruction block indicated by the predicted exit point. In some examples, the control unit is further configured to, based on the predicted exit point, speculatively fetch a data operand for a register read instruction for a next instruction block indicated by the predicted exit point. In some examples, the control unit is further configured to, based on the predicted exit point, speculatively fetch a data operand for a memory load instruction for a next instruction block indicated by the predicted exit point.

In some examples of the disclosed apparatus, metadata is stored in the memory as one or more of the following forms: as a header of the instruction block, in a memory location disjoint from the instruction block, in a memory generated by decoding the instruction block, and/or information in a memory generated by a previous execution of the instruction block. In some examples, the apparatus further comprises computer-readable storage media storing data for an instruction block header and for the instructions in the instruction block.

In some examples of the disclosed technology, a method of operating a processor (e.g., a block-based or EDGE ISA processor) includes producing a graph or tree representing control flow of an instruction block, the instruction block comprising instructions executable by the processor and producing an exit prediction for the instruction block based at least in part on the graph or tree. In some examples, the method further includes speculatively fetching, decoding, and/or executing a next instruction block indicated by the exit prediction before the instruction block commits. In some examples, the graph or tree is a directed acyclical graph (DAG) produced by, prior to initiating execution of the instruction block, generating the DAG from object code for the instruction block and storing the DAG in a computer-readable storage device or memory. In examples, the graph or tree is a directed acyclical graph (DAG) produced by, after initiating execution of the instruction block, decoding at least one instruction of the instruction block to determine at least a portion of control flow for the instruction block.

In some examples of the method, the graph or tree is a directed acyclical graph (DAG) produced by transforming source code and/or object code into object code executable by the processor, and the instruction block encodes at least a portion of data for the DAG. In some examples, the graph or tree is a directed acyclical graph (DAG) produced by executing the instruction block and storing data representing likelihoods associated with control flow of the instruction block. In some examples, the graph or tree includes metadata indicating an exit type for at least one exit path of the instruction block. In some examples, the graph or tree includes metadata indicating a target block for at least one exit path of the instruction block. In some examples, the graph or tree represents some, but not all, control flow and exit points for the instruction block. In some examples, one or more computer-readable storage media store computer-readable instructions for an instruction block that when executed by a block-based processor, cause the processor to perform one or more of the disclosed methods for operating a block-based processor.

In some examples of the disclosed technology, one or more computer-readable storage media store computer-readable instructions for an instruction block that when executed by a block-based processor, cause the processor to perform a method, the computer-readable storage media including metadata encoding a representation of at least a portion of control flow topology of the instruction block. In some examples, the metadata are generated by analyzing predicates encoded in source code and/or object code for the instruction block to determine control flow for one or more instructions of the instruction block and transforming the source code and/or object code into computer-executable code for the instruction block, the transformed code including hints for likely predicates associated with one or more exit points of the instruction block. In some examples, the analyzing and transforming are performed by a compiler that stores object code in a computer-readable storage medium. In some examples, the analyzing and transforming are performed by a just-in-time compiler and/or interpreter. In some examples, the analyzed object code includes object for another architecture processor than the block-based processor, and the transforming includes converting instructions from the other architecture (e.g., a RISC or CISC processor architecture) to a block-based or EDGE ISA processor. In some examples, the instruction block is generated by executing the instruction block one or more times with a block-based processor; and storing the metadata, the metadata further including evaluated predicate values for one or more predicates of the instruction block and/or exit point frequency for one or more exit points of the instruction blocks.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus comprising one or more block-based processor cores, at least one of the cores comprising:
one or more execution units configured to execute instruction blocks, each of the instruction blocks having one or more exit points; and
a control unit configured to execute a current one of the instruction blocks by:
reading metadata stored in a memory associated with the current instruction block, and
based on the read metadata, generating a predicted one of the exit points which will be taken upon executing the current instruction block.

2. The apparatus of claim 1, wherein the control unit is further configured to:
decode an instruction block by generating metadata representing at least a portion of control flow of the decoded instruction block; and
store the metadata in the memory.

3. The apparatus of claim 1, wherein the control unit is further configured to:
generate metadata for executing instruction blocks representing likelihoods of one or more control paths of the instruction block being taken; and
store the metadata in the memory.

4. The apparatus of claim 1, wherein the control unit is further configured to:
based on the predicted exit point, speculatively fetch and execute a next instruction block indicated by the predicted exit point.

5. The apparatus of claim 1, wherein the control unit is further configured to:
based on the predicted exit point, speculatively fetching a data operand for a register read instruction for a next instruction block indicated by the predicted exit point.

6. The apparatus of claim 1, wherein the control unit is further configured to:
based on the predicted exit point, speculatively fetching a data operand for a memory load instruction for a next instruction block indicated by the predicted exit point.

7. The apparatus of claim 1, wherein the metadata is stored in the memory as one or more of the following forms: as a header of the instruction block, in a memory location disjoint from the instruction block, in a memory generated by decoding the instruction block, or as information in a memory generated by a previous execution of the instruction block.

8. The apparatus of claim 1, wherein the apparatus further comprises computer-readable storage media storing data for an instruction block header and for the instructions in the instruction block.

9. A method of operating a processor, the method comprising:
producing a graph or tree representing control flow of an instruction block, the instruction block comprising instructions executable by the processor; and
producing an exit prediction for the instruction block based at least in part on the graph or tree.

10. The method of claim 9, further comprising speculatively fetching, decoding, and/or executing a next instruction block indicated by the exit prediction before the instruction block commits.

11. The method of claim 9, wherein the graph or tree is a directed acyclical graph (DAG) produced by, prior to initiating execution of the instruction block, generating the DAG from object code for the instruction block and storing the DAG in a computer-readable storage device or memory.

12. The method of claim 9, wherein the graph or tree is a directed acyclical graph (DAG) produced by, after initiating execution of the instruction block, decoding at least one instruction of the instruction block to determine at least a portion of control flow for the instruction block.

13. The method of claim 9, wherein:
the graph or tree is a directed acyclical graph (DAG) produced by transforming source code and/or object code into object code executable by the processor; and
the instruction block encodes data for the DAG.

14. The method of claim 9, wherein the graph or tree is a directed acyclical graph (DAG) produced by executing the instruction block and storing data representing likelihoods associated with control flow of the instruction block.

15. The method of claim 9, wherein the graph or tree comprises metadata indicating an exit type for at least one exit path of the instruction block.

16. The method of claim 9, wherein the graph or tree comprises metadata indicating a target block for at least one exit path of the instruction block.

17. The method of claim 9, wherein the graph or tree represents some, but not all, control flow and exit points for the instruction block.

18. One or more computer-readable storage media storing computer-readable instructions for an instruction block that when executed by a block-based processor, cause the processor to perform a method, the computer-readable storage media comprising:
metadata encoding a representation of at least a portion of control flow topology of the instruction block.

19. The computer-readable storage media of claim 18, wherein the metadata are generated by:
analyzing predicates encoded in source code and/or object code for the instruction block to determine control flow for one or more instructions of the instruction block; and
transforming source code and/or object code into computer-executable code for the instruction block, the transformed code including hints for likely predicates associated with one or more exit points of the instruction block.

20. The computer-readable storage media of claim 18, wherein the instruction block is generated by:
executing the instruction block one or more times with a block-based processor; and
storing the metadata, the metadata further including evaluated predicate values for one or more predicates of the instruction block and/or exit point frequency for one or more exit points of the instruction block.
